(19) United States
(12) Patent Application Publication
(10) Pub. No.: US 2002/0055442 A1
(43) Pub. Date: May 9, 2002

(54) Method of reducing wear of metal surfaces and maintaining a hydrolytically stable environment in refrigeration equipment during the operation of such equipment

(76) Inventors: Nicholas E. Schnur, Cincinnati, OH (US); Christopher J. Costello, Duesseldorf (DE)

Correspondence Address: COGNIS CORPORATION, 2500 RENAISSANCE BLVD., SUITE 200, GULPH MILLS, PA, 19406

(21) Appl. No.: 09/840,738

(22) Filed: Apr. 23, 2001

Related U.S. Application Data
(60) Provisional application No. 60/201,538, filed on Apr. 26, 2000.

(51) Int. Cl. C 10M 1 5/38; C09K 5/04

(52) U.S. Cl. 508/485; 252/68

(57) ABSTRACT

A method of improving wear of metal surfaces and maintaining a hydrolytically stable environment in refrigeration equipment during the operation of the equipment. The method involves contacting the metal surfaces with an ester lubricant base stock comprising blends of esters of neopentyl glycol and 2-ethylhexanoic acid and neopentyl glycol and at least one straight chain acid of four to ten carbon atoms and having a viscosity of about ISO 7-10. The lubricant can also be used in a working fluid with a chlorine-free fluoro-group heat transfer fluid such as 1,1,1,2-tetrafluoroethane.

### BACKGROUND OF THE INVENTION

Field of the Invention

This invention relates to a method of reducing wear of metal surfaces and maintaining a hydrolytically stable environment in refrigeration equipment during the operation of that equipment to prevent capillary tube plugging. The method employs a polyol ester lubricant base stock. The ester lubricant base stock may be used alone or compounded with additional ingredients. The ester lubricant base stock and compounded lubricants are typically used in refrigeration equipment as part of a refrigerant working fluid which also comprises one or more substantially chlorine-free fluoro-group containing heat transfer fluids such as pentafluoroethane, 1,1-difluoroethane, 1,1,1-trifluoroethane, difluoromethane and 1,1,1,2-tetrafluoroethane.

### STATE OF RELATED ART

In the operation of refrigeration equipment, internal metal surfaces tend to become worn from operation. Such wear will produce metal particles that may clog capillary tubing on the compressor and are unacceptable commercially. In addition, the metal surfaces may in time become so worn as to interfere with the proper functioning of the equipment.

It is also necessary to avoid plugging of capillary tubing by salts of carboxylic acid, which is a problem if the lubricants are not hydrolytically stable, as hydrolytically unstable lubricants react with water to form carboxylic acid and alcohol.

In low power compressors, a certain minimum viscosity is beneficial to avoid undesired depletion of the lubricant from those surfaces of refrigeration machinery that need lubrication during operation, but are not immersed in the refrigerant working fluid, e.g., during periods in which the compressor and other moving parts of the refrigeration system are idle. Nevertheless, the refrigeration industry prefers relatively low viscosity lubricants (i.e. lubricants of ISO 7-10). Such low viscosity lubricants improve operating efficiency of refrigeration equipment and therefore reduce their power consumption. However, the use of such low viscosity refrigerant lubricants based on esters of branched acids results in greater wear of metal surfaces during the operation of the refrigeration equipment compared with lubricants based on esters of straight chain acids. Low viscosity ester refrigerant lubricants made from straight chain acids are relatively less hydrolytically stable than low viscosity ester lubricants made with alpha-branched acids.

Mutual miscibility between the chlorine-free fluoro-group heat transfer fluid refrigerant and lubricant is also very important, as the lubricant should not separate from the refrigerant over the entire range of operating temperatures. If the miscibility between the lubricant and refrigerant is low, moving parts of the refrigeration system may seize as a result of inadequate lubrication.

Accordingly, it is an object of the present invention to provide a method that improves wear of internal metal surfaces and maintains a hydrolytically stable environment in refrigeration equipment during the operation of such equipment, and that employs the preferred low viscosity refrigerant lubricants. Another object of the invention is to provide a lubricant that improves wear, protects against corrosion of metal surfaces and is also mutually miscible with the chlorine-free fluoro-group heat transfer fluid, especially to the very low temperatures at which such equipment is operated.

### SUMMARY OF THE INVENTION

The invention provides a method of improving wear resistance of metal surfaces and maintaining a hydrolytically stable environment of metal surfaces in refrigeration equipment during the operation thereof. The method employs ester lubricant base stocks, which include esters formed from both straight chain carboxylic acids and branched chain acids or lubricant base stocks of esters of mixtures of straight and branched chain acids.

The lubricants of the invention have the preferred viscosity grades and are highly miscible with chlorine-free fluoro-group-containing heat transfer fluids, particularly chlorine-free heat transfer fluids, comprising pentafluoroethane, 1,1 difluoroethane, 1,1,1-trifluoroethane, difluoromethane and 1,1,1,2-tetrafluoroethane and mixtures thereof, over a wide temperature range. The invention also provides a lubricant composition which consists essentially of an ester lubricant base stock. The base stock is preferably a blend formed from at least the following two esters. In the blend, one of these esters is formed by reacting neopentyl glycol and a source of 2-ethylhexanoic acid. The second ester is formed by reacting neopentyl glycol and at least one straight chain acid having between four and ten carbon atoms. In other embodiments, this acid mixture comprises up to seven straight chain acids having between four and ten carbon atoms. The ester can also be formed in situ by reacting neopentyl glycol and a mixture of 2-ethylhexanoic acid and at least one of the straight chain acid(s).

Another ester lubricant blend of the invention is formed by a mixture of the above-identified neopentyl glycol esters with either an ester that is the reaction product of a polyol selected from the group consisting of pentaerythritol, dipentaerythritol, tripentaerythritol, or mixtures thereof, and 2-ethylhexanoic acid or an ester that is the reaction product of a polyol selected from the group consisting of pentaerythritol, dipentaerythritol, tripentaerythritol and mixtures thereof and at least one straight chain acid having between four and ten carbon atoms.

Another lubricant base stock blend of the invention is a blend of two ester mixtures. The first ester mixture comprises an ester that is the reaction product of neopentyl glycol and at least one straight chain acid of between four and ten carbon atoms and an ester that is the reaction product of a polyol selected from the group consisting of pentaerythritol, dipentaerythritol, tripentaerythritol and mixtures thereof, and a mixture of at least one straight chain acid of between four and ten carbon atoms. The second ester mixture comprises an ester that is the reaction product of neopentyl glycol and a source of 2-ethylhexanoic acid and an ester that is the reaction product of a polyol selected from the group consisting of pentaerythritol, dipentaerythritol, tripentaerythritol and mixtures thereof, and 2-ethylhexanoic acid.

The resulting ester lubricant base stock blends have a preferred viscosity range of ISO 7-10 (i.e., 6.12 to 11.0 centistokes at 40° C.) and a hydrolytically stability TAN result of not more than 50. This lubricant blend also imparts wear resistance to a metal surface so that wear is not more than 0.60 mm for an ISO 7 lubricant and 0.65 mm for an ISO 10 lubricant, using the standard Four Ball Test under the following conditions (20 kg, 1200 rpm, 107° C. 1 hr.).

The above-described ester lubricant may be used as such, or, depending on the end use, may have one or more additives incorporated therein to provide a compounded lubricant. However, a further desirable feature of the invention is that the lubricant does not need to be blended with anti-wear additives to achieve good results in improving the wear resistance of metal surfaces of refrigeration equipment exposed to the lubricant in the course of operation.

The ester lubricant of the invention is used to particular advantage as a component of a refrigerant working fluid, together with various chlorine-free fluoro-group containing heat transfer fluids, especially 1,1,1,2-tetafluoroethane (R-134a.)

The refrigerant working fluids of the invention also produce very good results in practice in operating a refrigerator comprising cyclic compression, liquefaction, expansion and evaporation of a heat transfer fluid.

### DETAILED DESCRIPTION OF THE INVENTION

Except in the claims and the operating examples, or where otherwise expressly indicated, all numerical quantities in this description indicating amounts of material or conditions of reaction and/or use are to be understood as modified by the term “about” in defining the broadest scope of the invention. Practice of the invention within the boundaries corresponding to the exact quantities is usually preferable, however.

For each of the esters which form the lubricant composition of the invention, it is possible to obtain the same esters by reacting acid derivatives such as acid anhydrides, acyl chlorides, and esters of the acids instead of reacting the acids themselves. The acids are generally preferred for economy and are exemplified herein, but it is to be understood that the esters defined herein by reference to their reactive components can be equally well obtained by reaction of alcohols with the corresponding acid derivatives. The term “source of 2-ethylhexanoic acid” as used herein thus refers to the acid per se, as well as to the corresponding acid anhydride, acyl halide, and ester derivatives thereof.

Concerning the reactive components of the esters which form the lubricant composition of the invention, it is to be understood that although only the desired alcohols and acids are explicitly specified, some amount of the sort of impurities normally present in technical or industrial grade products may be tolerable in most cases. For example, “tech pentaerythritol” (PE) is often used as a source of pentaerythritol. Tech-pentaerythritol normally contains on the order of 85-90 weight percent of mono PE, along with 10-15 weight percent of dipentaerythritol (“DPE”) and 0-3% of tripentaerythritol (“TPE”), and is quite satisfactory for making high quality esters in many cases.

In practice, it has been found that reaction between the alcohol(s) and the acid(s) reactants of the respective esters proceeds more effectively if the quantity of acid charged to the reaction mixture initially is enough to provide an excess of 10-25% of equivalents of acid over the equivalents of alcohol reacted with the acid. (An equivalent of acid is defined for the purposes of this description as the amount containing one gram equivalent weight of carboxyl groups, whereas an equivalent weight of alcohol is the amount containing one gram equivalent weight of hydroxyl groups.) The composition of the mixture of acids and alcohols that have actually reacted can be determined by analysis of the ester product for its acyl group content.

In making the ester product, according to this invention, the acid reacted will be lower boiling than the alcohol(s) reacted and the product ester(s). When this condition obtains, it is preferred to remove the bulk of any excess acid remaining at the end of the esterification reaction by distillation, most preferably at low pressure, on the order of 1-5 torr.

After such vacuum distillation, the product is often ready for use as a lubricant blending stock according to this invention. If further refinement of the product is desired, the content of free acid in the product after the first vacuum distillation may be further reduced by treatment with epoxy esters, as described in U.S. Pat. No. 3,485,754, or by neutralization with any suitable alkaline material, such as lime, alkali metal hydroxides, or alkali metal carbonates.

If treatment with epoxy esters is used, excess epoxy esters may be removed by a second distillation under very low pressure, while the product of reaction between the epoxy ester and residual acid may be left behind in the product without harm. If alkali neutralization is used as the refinement method, subsequent washing with water, to remove any unreacted excess fatty acid neutralized by the alkali, is strongly preferred before using the product in forming a lubricant ester blend.

Ester base stock blends according to this invention, and having a viscosity of ISO 7, consist essentially of (i) about 10 to about 90 weight percent, and preferably 30 to 70 weight percent, of a first ester formed from neopentyl glycol and a source of 2-ethylhexanoic acid and (ii) about 90 weight percent to about 10 weight percent, and preferably 70 to 30 weight percent, of a second ester formed from neopentyl glycol and at least one straight chain acid of between four and ten carbon atoms. The straight chain acid typically has the following weight percentages of acids of four to ten carbon atoms.

| | Weight Percent |
|---|---|
| nC₄ | 0.9% |
| nC₅ | 4% |
| nC₆ | 26% |
| nC₇ | 30% |
| nC₈ | 12% |
| nC₉ | 27% |
| nC₁₀ | 0.1% |

Instead of forming ester blends, the ester can be made in situ. For example, the two-ester blend can be prepared by reacting neopentyl glycol with a mixture of 2-ethylhexanoic acid and at least one straight chain acid having between four and ten carbon atoms. Similarly, the three component ester lubricant base stock blends described above can also be prepared in situ by the reaction of mixtures of the referenced acids and polyols.

In another embodiment, additional esters may be included in the two-component base stock blend described above. For example, this base stock blend may include a third ester. The third ester is preferably an ester that is the reaction product of a polyol selected from the group consisting of pentaerythritol, dipentaerythritol, tripentaerythritol and mixtures thereof, and 2-ethylhexanoic acid or an ester that is the reaction product of a polyol selected from the group consisting of pentaerythritol, dipentaerythritol, tripentaerythritol and mixtures thereof and a mixture of at least two straight chain acids having between four and ten carbon atoms.

In an additional preferred embodiment, an ester lubricant base stock blend having a viscosity of ISO 10 may be formed from two mixtures of esters. The first ester mixture comprises about 70 weight percent to about 85 weight percent of an ester which is the reaction product of neopentyl glycol and a source of 2-ethylhexanoic acid and about 15 weight percent to about 30 weight percent of an ester that is the reaction product of a polyol selected from the group consisting of pentaerythritol, dipentaerythritol, tripentaerythritol and mixtures thereof and a source of 2-ethylhexanoic acid. The second ester mixture comprises about 5 weight percent to about 80 weight percent of an ester that is the reaction product of neopentyl glycol and at least one straight chain acid having between four and ten carbon atoms and about 80 weight percent to about 5 weight percent of an ester that is the reaction product of a polyol selected from the group consisting of pentaerythritol, dipentaerythritol, tripentaerythritol and mixtures thereof and at least one straight chain acid having between four and ten carbon atoms. In this preferred embodiment the ratio is about 10 to about 65 weight percent, more preferably about 20 to about 60 weight percent, and most preferably about 30 weight percent of the first ester mixture (of 2-ethylhexanoic acid esters), and about 35 to about 90 weight percent, more preferably about 40 to about 80 weight percent, and most preferably about 70 weight percent of the second ester mixture (of straight chain acid esters).

In another embodiment of the invention, the first or second ester can be added to a mixture of the third or fourth esters. In a further embodiment, one or more of the first through fourth esters can be replaced with an ester which is the reaction product of trimethylolpropane and n-C₅ acid.

The multi-component blends are conveniently formulated by preparing an initial blend of straight chain esters and an initial blend of branched chain esters and combining the initial blends to give the final blend.

Under some conditions of use, the ester base stocks described herein will function satisfactorily as a complete lubricant. It is generally preferable, however, for a complete lubricant to contain other materials generally known in the art as additives, such as anti-oxidants and thermal stability improvers, corrosion inhibitors, metal deactivators, lubricity agents, viscosity index improvers, pour and/or floc point depressants, detergents, dispersants, foam-promoting agents, acid scavengers, anti-foaming agents, and extreme pressure resistant additives. Many additives may impart both anti-wear and extreme pressure resistance properties, or function both as a metal deactivator and a corrosion inhibitor. Cumulatively, all additives preferably do not exceed 8% by weight, or more preferably do not exceed 5% by weight, of the total compounded formulation.

An effective amount of the foregoing additive types is generally in the range of 0.01 to 5% for the antioxidant compound, 0.01 to 5% for the corrosion inhibitor component, from 0.001 to 0.5% for the metal deactivator component, from 0.5 to 5% for the lubricity agents, from 0.01 to 2% for each of the viscosity index improvers and pour and/or floc point depressants, from 0.1 to 5% for each of the detergents and dispersants, from 0.001 to 0.1% for foam-promoting agents or anti-foam agents, and from 0.1-2% for the extreme pressure resistance components. All these percentages are by weight and are based on the total weight of the lubricant composition. It is to be understood that more or less than the stated amounts of additives may be more suitable to particular circumstances or applications, and that a single molecular type or a mixture of types may be used for each type of additive component.

The foregoing examples of suitable additives are intended to be merely illustrative and not limiting, except as circumscribed by the appended claims.

Examples of suitable anti-oxidants and thermal stability improvers are diphenyl-, dinaphthyl- and phenyl-naphtyl-amines, in which the phenyl and naphthyl groups can be substituted, e.g., N,N′-diphenyl phenylenediamine, p-octylidiphenylamine, p,p-dioctyldiphenylamine, -phenyl-1-naphthyl amine, N-phenyl-2-naphthyl amine, -(p-dodecyl)-phenyl-2-naphthyl amine, di-1-naphthylamine, and di-2-naphthylamine; phenothiazines such as N-alkylphenothiazines; amino (-bisbenzyl); and hindered phenols such as 6-(5-butyl) phenol, 2,6-di (5-butyl) phenol, 4-methyl-2,6-di-(5-butyl) phenol, 4,4,′-methylenebis (-2,6-di-(5-butyl) phenol, 4,4′-methylenebis (-2, 6-di-(5-butyl) phenol), and the like.

Examples of suitable cuprous metal deactivators are imidazole, benzamidazole, 2-mercaptobenzothiazole, 2,5-dimercaptothiadiazole, salicylidine-propylenediamine, pyrazole, benzotriazole, tolutriazole, 2-methylbenzamidazole, 3,5-dimethyl pyrazole, and methylene bis-benzotriazole. Benzotriazole derivatives are preferred. Other examples of more general metal deactivators and/or corrosion inhibitors include organic acids and their esters, metal salts, and anhydrides, e.g., N-oleyl-sarcosine, sorbitan monooleate, lead naphthenate, dodecenyl-succinic acid and its partial esters and arnides, and 4-nonylphenoxy acetic acid; primary, secondary, and tertiary aliphatic and cycloaliphatic amines and amine salts of organic and inorganic acids, e.g., oil-soluble alkylammonium carboxylates; heterocyclic nitrogen-containing compounds, e.g., thiadiazoles, substituted imidazolines, and oxazolines; quinolines, quinones, and anthraquinones; propyl gallate; barium dinonyl naphthalene sulfonate; ester and amide derivatives of alkenyl succinic anhydrides or acids, dithiocarbamates, dithiophosphates, amine salts of alkyl acid phosphates and their derivatives.

Examples of suitable lubricity agents include siloxane polymers, polyoxyalkene polymers, polyalkyleneglycol and long chain derivatives of fatty acids and natural oils such as esters, amines, amides, imidazolines, and borates.

Examples of suitable viscosity index improvers include poly-methacrylates, copolymers of vinyl pyrrolidone and methacrylates, polybutenes, and styrene-acrylate copolymers.

Examples of suitable pour point and/or floc point depressants include poly-methacrylates such as methacrylate-ethylene-vinyl acetate terpolymers; alkylated naphthalene derivatives, and products of Friedel-Crafts catalyzed condensation of urea with naphthalene or phenols.

Examples of suitable detergents and/or dispersants include poly-butenylsuccinic acid amides; polybutenyl phosphonic acid derivatives; long chain alkyl substituted aromatic sulfonic acids and their salts; methyl salts of alkyl sulfides, of alkyl phenols, and of condensation products of alkyl phenols and aldehydes.

Examples of suitable anti-foam agents include silicone polymers, siloxane polymers and polyoxyalkene polymers and some acrylates.

Examples of foam promoters include than the silicone polymers used as anti-foam agents, siloxane polymers and polyoxyalkene polymers.

Examples of suitable extreme pressure resistance agents include sulfurized fatty acids and fatty acid esters, such as sulfurized octyl tallate; sulfurized terpenes; sulfurized olefins; organopolysulfides; organo phosphorus derivatives including amine phosphates, alkyl acid phosphates, dialkyl phosphates, aminedithiophosphates, trialkyl and triaryl phosphorothionates, trialkyl and triaryl phosphines, and dialkylphosphites, e.g., amine salts of phosphoric acid monohexyl ester, amine salts of dinonylnaphthalene sulfonate, triphenyl phosphate, trinaphthyl phosphate, diphenyl cresyl and dicresyl phenyl phosphates, naphthyl diphenyl phosphate, triphenylphosphorothionate; dithiocarbamates, such as an antimony dialkyl dithiocarbamate; chlorinated and/or fluorinated hydrocarbons, and xanthates.

Under some conditions of operation, it is believed that the presence in lubricants of the types of polyether polyols that have been prominent constituents of certain prior art lubricant base stocks reported to be useful with fluorocarbon refrigerant working fluids are less than optimally stable and/or inadequately compatible with some of the most useful lubricant additives. Thus, in one embodiment of this invention, it is preferred that the lubricant base stocks and lubricant be substantially free of such polyether polyols. By “substantially free,” it is meant that the compositions contain no more than about 10% by weight, preferably no more than about 2.6% by weight and more preferably no more than about 1.2% by weight of the materials noted.

In formulating a refrigerant working fluid according to this invention, the selected heat transfer fluid and the lubricant should preferably have chemical characteristics and be present in such a proportion to each other that the working fluid remains homogeneous, i.e., free from visually detectable phase separations or turbidity, over the entire range of operating temperatures to which the working fluid is exposed during operation of a refrigeration system in which the working fluid is used. This temperature range may vary from −60° C. to as much as 175° C. It is often adequate if the working fluid remains a single phase up to +30° C., although it is increasingly more preferable if the single phase behavior is maintained up to 40, 56, 71, 88 or 100° C. Similarly, it is often adequate if the working fluid compositions remain a single phase when chilled to 0° C., although it is increasingly more preferable if the single phase behavior persists to −10, −20, −30, −40 or −55° C. Single phase mixtures with chlorine-free fluoro-group containing heat transfer fluids can often be obtained with blended ester lubricants as described above, with the most preferred esters being the ones most likely to give such single phase behavior over a wide temperature range.

Inasmuch as it is often difficult to predict exactly how much lubricant will be mixed with the heat transfer fluid to form a working fluid, it is most preferable if the lubricant composition forms a single phase in all proportions with the heat transfer fluid over the temperature ranges noted above. This, however, is not a rigid requirement, and it is often sufficient if there is single phase behavior over the entire temperature range for a working fluid mixture containing up to 1% by weight of lubricant according to this invention. Single phase behavior over a temperature range for mixtures containing up to 2, 4, 10 and 15% by weight of lubricant is successively more preferable.

In the practice of this invention, the lubricant base stock is used in a process of operating refrigerating machinery in such a manner that the lubricant improves wear resistance and corrosion resistance of metal surfaces of refrigeration equipment during the operation of the equipment. According to this method, the surfaces are in contact with the lubricant alone, or as part of a working fluid in which the lubricant forms a single phase with chlorine-free fluoro-group containing heat transfer fluids.

The operable and preferred ranges of viscosity and variation of viscosity with temperature for lubricant compositions according to this invention are generally the same as established in the art for lubricants to be used in refrigeration systems together with a heat transfer fluid, particularly for a fluorocarbon and/or chlorofluorocarbon heat transfer fluid. In general, as noted above, it is preferred that lubricants according to this invention have International Organization for Standardization (“ISO”) viscosity grade numbers between 7 and 10. The viscosity ranges for ISO viscosity grade numbers from ISO 2 to ISO 15 are given in Table 1.

TABLE I

Viscosity Range in Centistokes
at 40° C.:

| ISO Viscosity Grade No. | Minimum | Maximum |
|---|---|---|
| 2 | 1.98 | 2.42 |
| 3 | 2.88 | 3.53 |
| 5 | 4.14 | 5.06 |
| 7 | 6.12 | 7.48 |
| 10 | 9.00 | 11.0 |
| 15 | 13.5 | 16.5 |

General Ester Synthesis Procedure

The alcohol and acid to be reacted, together with a suitable catalyst such as dibutyltin diacetate, tin oxalate, phosphoric acid, and/or tetrabutyl titanate, are charged into a round-bottomed flask equipped with a stirrer, thermometer, nitrogen sparging means, condenser, and a recycle trap. Acid is charged in about 15% molar excess over the alcohol. The amount of catalyst is from 0.02 to 0.1% by weight of the weight of the total acid and alcohol reacted.

The reaction mixture is heated to a temperature between about 220 and 230° C., and water from the resulting reaction was collected in the trap while refluxing acids are returned to the reaction mixture. Partial vacuum is maintained above the reaction mixture as necessary to achieve a reflux.

The reaction mixture is sampled occasionally for determination of hydroxyl number, and after the hydroxyl number falls below 5.0 mg of KOH per gram of mixture, the majority of the excess acid is removed by distillation after applying the highest vacuum obtainable with the apparatus used, while lowering the temperature to about 190° C. The reaction mixture is then cooled, and any residual acidity is removed, if desired, by treatment with lime, sodium hydroxide, or epoxy esters. The resulting lubricant or lubricant base stock is dried and filtered before blending and phase compatibility testing.

The esters identified hereinbelow were subjected to a Four Ball Test and an autoclave hydrolytic stability test.

The Four Ball Test measures wear of metal surfaces, which is expressed in millimeters. According to this test, the less wear the better. The test was carried out in accordance with ASTM 4122, run at 20 kg at 1200 rpm with a temperature of 107° C. for one (1) hour. The result of the Four Ball Test should be no more than 0.60 mm for ISO 7 lubricants and 0.65 mm for ISO 10 lubricants to reduce wear of metal surfaces.

The hydrolytic stability test was conducted under the following conditions. Five grams of iron were placed in a test tube containing twenty grams lubricant. The test tube was maintained in an autoclave at 149° C. for 72 hours in a saturated aqueous environment under a nitrogen blanket. According to the test, the hydrolytic stability TAN result for the lubricant should not exceed 50, and preferably not exceed 30.

The preparation of ester lubricant base stocks of the invention is described in further detail in the following examples.

### EXAMPLE 1

In Example 1, esters having a viscosity of ISO 7 were prepared, blended and tested for hydrolytic stability and wear resistance. The ester identified as Ester A is formed from neopentyl glycol and an acid mixture consisting of 0.9 weight percent nC₄, 4 weight percent nC₅, 26 weight percent nC₆, 30 weight percent nC₇, 12 weightpercent nC₈, 27 weight percent nC₉ and 0.1 weight percent nC₁₀. The ester identified as Ester B is formed from neopentyl glycol and 2-ethylhexanoic acid. Examples 1 and 10-11 are included as a basis of comparison. Examples 2 through 9 represent ester blends made according to the invention.

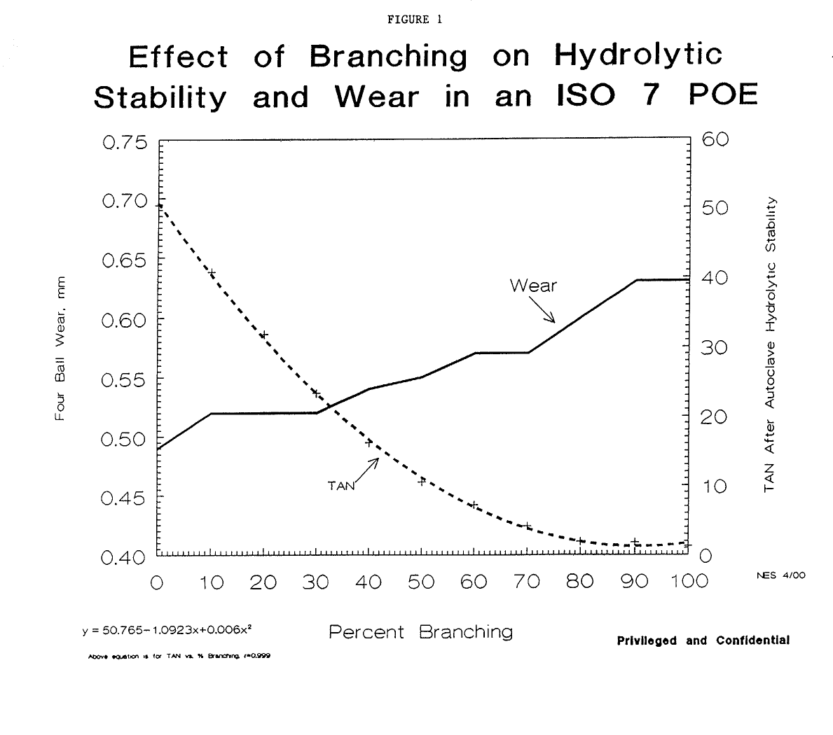

According to the results set forth in Table 2 below, which are graphically represented in FIG. 1, the ester blends exhibit superior hydrolytic stability TAN results, compared with the hydrolytic stability TAN results obtained using the unblended ester of the straight chain acid mixture. The ester blends additionally produce better wear results on metal surfaces compared with the wear results of the neopentyl glycol ester of 2-ethylhexanoic acid.

TABLE 2
Blends of ISO 7 Esters, Weight Percent

| | 1 | 2 | 3 | 4 | 5 | 6 | 7 | 8 | 9 | 10 | 11 |
|---|---|---|---|---|---|---|---|---|---|---|---|
| Ester A | 100 | 90 | 80 | 70 | 60 | 50 | 40 | 30 | 20 | 10 | — |
| Ester B | — | 10 | 20 | 30 | 40 | 50 | 60 | 70 | 80 | 90 | 100 |
| Hydro.Stab | | | | | | | | | | | |
| Final TAN | 50.4 | 40.8 | 31.9 | 23.4 | 16.2 | 10.5 | 7.2 | 4.1 | 1.9 | 1.8 | 1.3 |
| Four Ball Wear | | | | | | | | | | | |
| mm | 0.48 | 0.52 | 0.52 | 0.52 | 0.54 | 0.55 | 0.57 | 0.57 | 0.60 | 0.63 | 0.63 |
| 134aMisc., ° F. | <−70 | <−70 | <−70 | <−70 | <−70 | <−70 | <−70 | <−70 | <−70 | <−70 | <−70 |

### EXAMPLE 2

In Example 2, esters having a viscosity of ISO 10 were prepared, blended and tested for hydrolytic stability and metal wear. The ester identified as Ester C is a blend of 60% percent Ester A and 40% percent Ester E. Ester E is formed from a polyol mixture consisting of 85% pentaerythritol, 12% dipentaerythritol and 3% tripentaerythritol and a mixture of straight chain acids consisting of 0.4 weight percent nC₄, 50.82 weight percent nC₅, 9.96 weight percent nC₆, 13.40 weight percent nC₇, 14.84 weight percent nC₈, 5.43 weight percent nC₉, and 5.17 weight percent nC₁₀. The ester identified as Ester D is a blend of Ester B and Ester F. Ester F is formed from a polyol mixture consisting of 98 weight percent pentaerythritol and 2 weight percent dipentaerythritol, and 2-ethylhexanoic acid. Examples 12 and 19-22 are not embodiments of this invention and are included as a basis of comparison. Examples 13 through 18 represent multi-component ester blends made according to the invention.

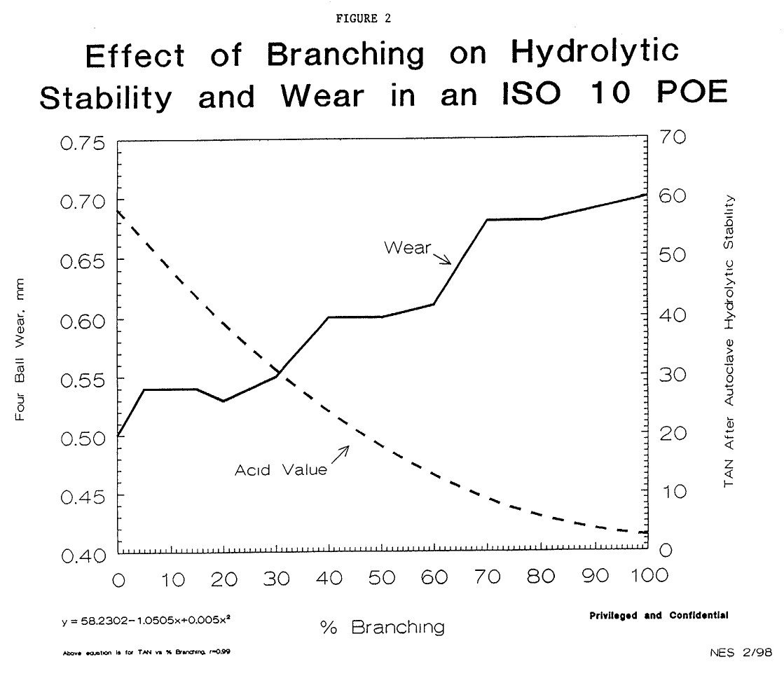

According to the results set forth in Table 3 below, which are graphically presented in FIG. 2, the ester blends exhibit better hydrolytic stability TAN results compared with the hydrolytic stability TAN results of Ester C, which is a blend of esters formed only from a mixture of straight chain acids. The ester blends also produce better wear results on metal surfaces compared with the wear results produced by Ester D, which is a blend of esters formed from 2-ethylhexanoic acid as the acid component.

TABLE 3
Blends of ISO 10 Esters, Weight Percent

| | 12 | 13 | 14 | 15 | 16 | 17 | 18 | 19 | 20 | 21 | 22 |
|---|---|---|---|---|---|---|---|---|---|---|---|
| Ester C | 100 | 90 | 80 | 70 | 60 | 50 | 40 | 30 | 20 | 10 | — |
| Ester D | — | 10 | 20 | 30 | 40 | 50 | 60 | 70 | 80 | 90 | 100 |
| Hydro. Stab. | | | | | | | | | | | |
| Final TAN | 61 | 47 | 38 | — | 29.2 | — | — | 6.8 | — | — | 3 |
| Four Ball Wear | | | | | | | | | | | |
| mm | 0.50 | 0.54 | 0.53 | 0.55 | 0.60 | 0.60 | 0.61 | 0.68 | 0.68 | 0.69 | 0.70 |

The invention claimed is:

1. A method of improving wear resistance of metal surfaces and maintaining a hydrolytically stable environment in refrigeration equipment during the operation of said equipment, said method comprising lubricating the metal surfaces with an ester lubricant base stock blend comprising at least two esters and including from about 10 weight percent to about 90 weight percent of a first ester, which is the reaction product of neopentyl glycol and a source of 2-ethylhexanoic acid and about 90 weight percent to about 10 weight percent of a second ester which is the reaction product of neopentyl glycol and at least one straight chain acid having between four and ten carbon atoms, said blend optionally further including at least one of a third ester which is the reaction product of a polyol selected from the group consisting of pentaerythritol, dipentaerythritol, tripentaerythritol and mixtures thereof and a source of 2-ethylhexanoic acid, and a fourth ester which is the reaction product of a polyol selected from the group consisting of pentaerythritol, dipentaerythritol, tripentaerythritol and mixtures thereof and at least one straight chain acid having between four and ten carbon atoms, wherein the resulting ester lubricant base stock blend has a viscosity between about 6.12 to about 11.0 centistokes at 40° C., a hydrolytic stability TAN result of not greater than 50, and imparts a four ball wear resistance to the metal surface of not greater than 0.60 mm under four ball test conditions of 20 kg, at 1200 rpm, with a temperature of 107° C. for one hour.

2. A method according to claim 1, wherein said first and third esters together constitute from about 30 to about 70 weight percent of said blend, and said second and fourth esters together constitute from about 70 to about 30 weight percent of said blend.

3. A method of improving wear resistance of metal surfaces and maintaining a hydrolytically stable environment in refrigeration equipment during the operation of said equipment, said method comprising lubricating the metal surfaces with a working fluid which consists essentially of a chlorine-free fluoro-group containing heat transfer fluid and an ester lubricant base stock blend comprising at least two esters and including from about 10 weight percent to about 90 weight percent of a first ester, which is the reaction product of neopentyl glycol and a source of 2-ethylhexanoic acid and about 90 weight percent to about 10 weight percent of a second ester which is the reaction product of neopentyl glycol and at least one straight chain acid having between four and ten carbon atoms, said blend optionally further including at least one of a third ester which is the reaction product of a polyol selected from the group consisting of pentaerythritol, dipentaerythritol, tripentaerythritol and mixtures thereof and a source of 2-ethylhexanoic acid, and a fourth ester which is the reaction product of a polyol selected from the group consisting of pentaerythritol, dipentaerythritol, tripentaerythritol and mixtures thereof and at least one straight chain acid having between four and ten carbon atoms, wherein the resulting ester lubricant base stock blend has a viscosity between about 6.12 to about 11.0 centistokes at 40° C., a hydrolytic stability TAN result of not greater than 50, and imparts a four ball wear resistance to the metal surface of not more than 0.60 mm under four ball test conditions of 20 kg, at 1200 rpm, with a temperature of 107° C. for one hour, and the resulting working fluid remains in a single phase to at least as low as −40° C.

4. A lubricant composition useful in improving wear resistance of metal surfaces and maintaining a hydrolytically stable environment in refrigeration equipment contacted with said composition, said composition comprising an ester lubricant base stock blend comprising at least two esters and including from about 10 weight percent to about 90 weight percent of a first ester, which is the reaction product of neopentyl glycol and a source of 2-ethylhexanoic acid and about 90 weight percent to about 10 weight percent of a second ester which is the reaction product of neopentyl glycol and at least one straight chain acid having between four and ten carbon atoms, said blend optionally further including at least one of a third ester which is the reaction product of a polyol selected from the group consisting of pentaerythritol, dipentaerythritol, tripentaerythritol and mixtures thereof and a source of 2-ethylhexanoic acid, and a fourth ester which is the reaction product of a polyol selected from the group consisting of pentaerythritol, dipentaerythritol, tripentaerythritol and mixtures thereof and at least one straight chain acid having between four and ten carbon atoms, wherein the resulting ester lubricant base stock blend has a viscosity between about 6.12 to about 11.0 centistokes at 40° C., a hydrolytic stability TAN result of not greater than 50, and imparts a four ball wear resistance to the metal surface not greater than 0.60 mm under four ball test conditions of 20 kg at 1200 rpm with a temperature of 107° C. for one hour.
